(19) United States
(12) Patent Application Publication
(10) Pub. No.: US 2013/0208105 A1
(43) Pub. Date: Aug. 15, 2013

(54) INSPECTION APPARATUS, MANUFACTURING SYSTEM WITH INSPECTION APPARATUS AND INSPECTION METHOD FOR VESSELS

(71) Applicants: Anton Schmidt, Bernau im Schwarzwald (DE); Michael K. Friedrich, Wuerenlos (CH); Oliver Zind, Karlsruhe (DE)

(72) Inventors: Anton Schmidt, Bernau im Schwarzwald (DE); Michael K. Friedrich, Wuerenlos (CH); Oliver Zind, Karlsruhe (DE)

(73) Assignee: MALL + HERLAN, Pfyn (CH)

(21) Appl. No.: 13/812,601

(22) PCT Filed: Jul. 25, 2011
(86) PCT No.: PCT/EP11/03716

§ 371 Date: Apr. 7, 2013

(30) Foreign Application Priority Data
Jul. 27, 2010 (DE) 10 2010 032 410.8

(51) Int. Cl. G01N 21/95

(52) U.S. Cl. CPC G01N 21/95
USPC 348/92; 29/650

(57) ABSTRACT

An inspection apparatus for examining vessels fixedly arranged on a machine tool. The apparatus includes a camera having a first optical component. The camera is coupled to an image processing unit and is arranged in a positionally fixed manner with respect to a vessel to be inspected. The apparatus has a second, moveably mounted optical element, with the first, positionally fixed optical element and the second, moveably mounted optical element being operatively connected to the camera for image-recording at least one view in the direction of a vessel opening and at least one view in the direction of a side of the vessel to be inspected that faces away from the vessel opening. A manufacturing system for vessels, which includes an inspection apparatus, and a corresponding examination method, which can be carried out using the inspection apparatus, for testing the vessel quality after machining is also disclosed.

The present invention relates to an inspection apparatus by means of which vessels may be examined for defects. The invention further relates to a production unit by means of which these types of vessels are processed, and which contains an inspection apparatus according to the invention. Lastly, the present invention encompasses an inspection method by means of which vessels may be examined.

Vessels such as cans and bottles which are used to hold foods, chemicals, medicaments, and other materials must be examined for defects prior to filling and marketing in order to ensure that on the one hand the filling process proceeds without problems, and that on the other hand the contents of the vessels are not spoiled or impaired with respect to quality, and leakage of liquids is reliably prevented.

Frequently, vessels such as cans are shaped in the opening area by means of known shaping processes so that flanging is achieved on the vessel neck. This flanging is particularly suited for affixing a sealing closure foil or other closure element thereto, for example a valve. This requires that the flanging has no defects. To determine at an early time whether the shaping process has left damage on the can, or also whether bottle necks, which likewise have a bead-like opening enlargement on which bottle caps, for example, may be placed, are damaged, the bottles or cans are usually examined immediately after production. Known production methods use image recording technologies which enable the sensitive bottle or can neck to be recorded from the front, using image recording processes. It is known that when the bottles or cans leave the preceding processing unit, they are discharged from the unit and in the horizontal position are moved past a camera. The bottles or cans are fixed in a cup-shaped receptacle strictly by gravitational force, so that they are positioned only at the support point with a low level of accuracy and are present on the moving conveyor belt as a function of diameter in relation to the position of their longitudinal axis, which is disadvantageous for high-resolution image recording. In particular, minute damage such as scratches in the paint or tiny dents in the flanged rim, which require high image resolution, may be sufficient for liquids to escape from the vessel which is not precisely closed, or for oxygen, for example, to enter the vessel and adversely alter the contents by oxidation, for example.

The aim of known image recording processes is to image the bottle neck in frontal recordings; as the result of undercuts that are formed by flanged rims or bottle neck beads, areas situated beneath the plane of the bottle opening are not imaged or only inadequately imaged, and thus cannot be monitored.

Based on this prior art, there is a need to provide an improved inspection apparatus for examining vessels which allows enhanced image quality for determining defects in vessels. This object is achieved by the inspection apparatus having the features of Claim 1.

Furthermore, there is a need to provide an improved production unit by means of which vessels may be produced and processed, and which allows inline images of the vessel having enhanced recording quality to be acquired, it being desirable to capture not only a top view of a plane of the vessel neck, but also to achieve the most comprehensive imaging possible. This object is achieved by the production unit having the features of Claim 7.

A further object is to provide an improved inspection method which allows the quality of vessels to be realized directly in production in a precise and reliably reproducible manner. This object is achieved by the inspection method having the features of Claim 10.

Corresponding refinements of the apparatus and of the method are set forth in the respective subclaims.

One embodiment of an inspection apparatus according to the invention is used in the examination of vessels which are fixedly mounted on a processing machine.

The term “vessel” below is understood to mean a can which may be filled with a spray or some other liquid, for example, and which for this purpose is shaped in a processing machine such as a necking machine. Such cans are primarily made of metal. However, “vessel” may also be understood to mean a bottle, also glass or plastic bottles, as well as other containers such as vases and the like.

In this regard, the term “processing” may be understood to mean shaping as well as the application of a surface coating, smoothing the surface, or, in the case of glass processing, for example grinding or any other type of post-processing of a blank or a preform which is to be formed to produce the vessel.

The inspection apparatus of the present invention is used to determine damage of the surface of these types of vessels by image recording; scratches in a paint coating, as well as dents, flaked-off material particles, cracks or fissures, and other damage of the interior and exterior of the vessel may be understood as damage.

The inspection apparatus has a stand to which a camera, which is connected to an optical component such as one or more lenses or some other suitable optical component, is fastened. These types of cameras are known to those skilled in the art. The camera has a conventional image processing unit. The image processing unit may be connected, in a manner known to those skilled in the art, to further data-processing or image-processing units, for example for enlarging or storing recorded images or for making comparisons using data processing units, also possibly including coupling to a database in which comparative images of ideal or damage-free vessels are stored, so that when damage is detected and subsequent image comparison is carried out, the defective vessel may be immediately removed from the production unit or a conveying device coupled thereto.

The camera and an associated illumination device are held by a holding device which is connected to the stand. The optical component of the camera defines an image recording axis which faces in the direction of the vessel to be inspected, and which for this purpose is explicitly in a so-called “inspection position.” In this position the central longitudinal axis of the vessel to be inspected is aligned with the recording axis of the camera.

The inspection apparatus also has a component which is movable with respect to the stand, i.e., mobile. This component includes a retaining tube, inside of which a second optical component is situated. The retaining tube is situated coaxially with respect to the recording axis in an area between the camera and the vessel, and is movable parallel to the axis, in the direction of the vessel. The opening cross section of the movable retaining tube is larger than a maximum outer circumference of a section of the vessel to be inspected. While the vessel to be inspected is in the inspection position, the inspection apparatus is transferred into an image recording configuration wherein the retaining tube is moved over the vessel, so that at least the section of the vessel to be inspected is surrounded by the retaining tube. The beam path extends from the illumination device to the section of the vessel to be inspected, and from there extends over the second optical component to the first optical component of the camera.

In one embodiment of the invention, the holding device may be a jacket tube made of a metal, metal alloy, plastic, or fiber composite material, the central longitudinal axis of the jacket tube being aligned with the recording axis of the camera, and thus, also with the central longitudinal axis of the vessel in the inspection position. The outer circumference of the jacket tube is smaller than the opening cross section of the retaining tube, so that when the retaining tube is withdrawn from the image recording configuration it partially or completely surrounds the jacket tube. The next vessel to be inspected may then occupy the inspection position in an unhindered manner.

While the first optical component which is coupled to the camera is usually a lens or an arrangement of lenses, the second optical component may be a mirror, in particular a mirror having a concave curvature or a parabolic mirror, having a central through opening. This mirror situated in the retaining tube advantageously allows the vessel to be imaged all the way around, i.e., also on its side walls. The mirror has a through opening, and during the image recording is pushed to the desired extent across the vessel together with the movable mounting. The curvature of the mirror is configured in such a way that the optical system of the camera may also record the undercuts and walls via the mirror.

Alternatively, as a further optical component an endoscopic optical system may be situated in the retaining tube, which as the result of mounting in the retaining tube is held parallel to and centered with respect to the central longitudinal axis of the retaining tube. One end of the endoscopic optical system faces toward the camera. The endoscopic optical system is not connected to the camera, but a recording area of the camera is adjusted on the end face at the end of the endoscopic optical system via the first component or the lens in such a way that an image transmission from the endoscopic optical system to the camera occurs. The second end of the endoscopic optical system is oriented toward the vessel, which is in the inspection position, the vessel opening of which faces the endoscopic optical system in order to allow the second end to submerge into the interior of the vessel.

The present inspection apparatus is advantageously suitable for already being integrated inline in the production process and taking image recordings of the vessel at the end of the processing line when the final processing steps are concluded, while the vessel is still fixedly mounted on the processing machine. It is thus possible to create high-resolution, precise images which reveal the most minute damage to the vessels. A production unit for producing vessels, which includes at least one processing machine for processing the vessels, therefore has a moving conveying device that moves the vessels, which, however, are fixedly mounted on the conveying device. The vessels, fixedly mounted on the conveying device, pass by multiple processing stations in the processing machine, such as shaping devices, without the vessels having to be turned over.

In addition, the production unit according to the invention includes an inspection apparatus by means of which the vessel quality, as described above, may be examined after the processing. The term “vessel quality” is understood to mean that no damage is present on the surface, whereby the damage may range from cracks to scratches to material flaking and dents.

In the production unit according to the invention, the inspection apparatus is integrated by means of a stand in such a way that the camera, having an appropriate image processing device and an optical component which is connected to the camera, is able to suitably produce comprehensive images not only of the top view of the vessel neck, but preferably also of undercuts at inner or outer wall areas situated behind the neck.

If only images of the can neck or bottle neck or the opening plane thereof are to be recorded, a simple inspection apparatus may be used which includes a holding device, preferably a jacket tube made of metal, in which the camera is fastened to an illumination device. The beam path of the camera and the beam path of the illumination device correspondingly extend toward an image recording opening in the metal tube so that the exiting light beam may properly illuminate the object to be examined and the camera may take pictures.

According to the invention, the inspection apparatus is integrated inline in the production unit, and may be situated at the end of the processing machine. This has the advantage that the processed vessels are still fixedly mounted on the conveying device, and therefore in order to achieve optimal image quality do not wobble when images are produced.

The inspection apparatus, which includes the holding device which is fastened to the stand, and in which the camera together with the first optical component and the illumination device are fastened, is situated in the processing machine in relation to a vessel to be inspected, which is in an inspection position, in such a way that the camera together with the first optical component points along a recording axis in the direction of the vessel to be inspected, and the recording axis is aligned with a central longitudinal axis of the vessel in the inspection position.

The inspection apparatus may advantageously be coupled to the processing machine via a control device in order to control the inspection apparatus in coordination with the conveying device in such a way that the image recording for examining the vessel quality takes place during a holding phase of the conveying device, with the vessel to be inspected in the inspection position. This holding phase is specified by a time period that is necessary for a vessel to be processed by the processing machine. This holding phase, together with the fixed mounting of the vessels on the conveying device and the stationarily mounted camera, allows optimal image quality.

An inspection method for examining the quality of a vessel after it has been processed, which may be carried out on such a production unit, therefore includes the fastening of the vessels to the movable conveying device of the processing machine so that the vessels may be processed at multiple processing stations of the processing machine. In addition, in the processing machine the inspection apparatus in each case advantageously examines one of the vessels, which is in the inspection position in which the central longitudinal axis of the vessel is aligned with the recording axis of the camera. For the image recording of the corresponding vessel to be examined, the inspection apparatus is controlled by the control device in coordination with the conveying device, so that the inspection apparatus may examine the vessel, which is in the inspection position, when the conveying device is stopped. Such a holding phase is specified by the processing time of the vessels in the processing stations. The longest processing step determines the duration of the holding phase, which is usually very brief.

In order to take further pictures and also image the interior of the vessel or lateral wall sections and undercuts, as described above, an inspection apparatus may be used which has a movable component in addition to the static component.

According to this method procedure, the movable part components of the inspection apparatus, and thus the retaining tube having the second optical component, move(s) into the image recording configuration, parallel to the axis with respect to the recording axis in the direction of the vessel to be inspected, so that the section of the vessel to be inspected is situated in the retaining tube; however, the retaining tube may also be guided over the entire vessel.

The beam path correspondingly extends from the illumination device to the section of the vessel to be inspected, and from there extends over the second optical component to the first optical component of the camera.

It is particularly advantageous when the movable component is a retaining tube in which either a mirror, such as a parabolic mirror, or some other mirror having a concave curvature is situated, and which has a central through opening and in this regard may be guided over the object from which the image recording is to be produced. Undercuts may be easily recorded by moving the mirror along the vessel to be examined, so that the camera may now record the vessel not only in strictly a top view, but also indirectly in a comprehensive side view via the mirror optical system in the retaining tube. To record a comprehensive internal view of the vessel, a retaining tube having an endoscopic optical system may advantageously be used which may be guided into the interior of the can to be examined or the bottle to be examined while the retaining tube accommodates the vessel to be inspected, so that it is possible to examine practically any internal geometric shape.

These and other advantages are explained by the following description, with reference to the accompanying figures. Reference to the figures in the description is used to support the description and simplify understanding of the subject matter. Objects or parts of objects that are essentially identical or similar may be provided with the same reference numerals. The figures are merely schematic illustrations of exemplary embodiments of the invention, and show the following:

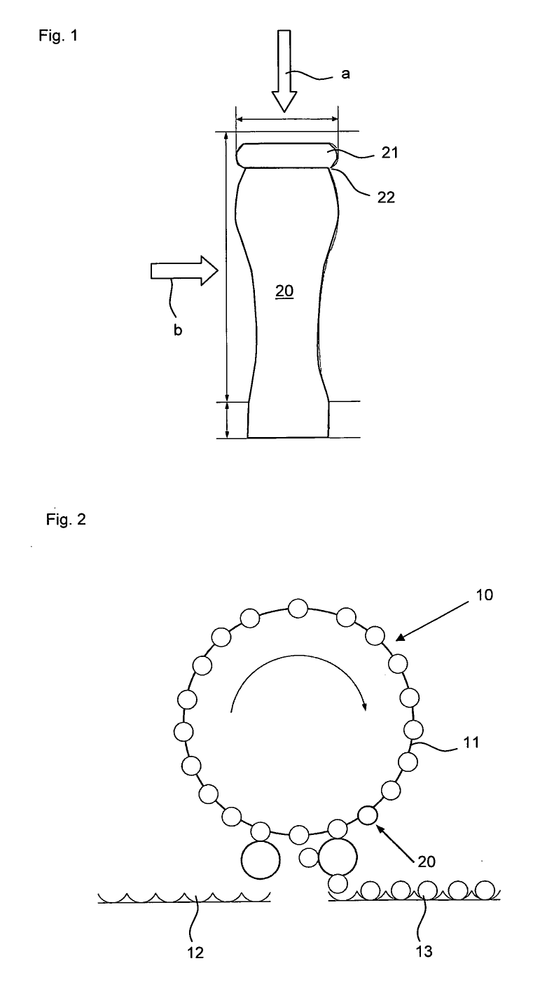

FIG. 1 shows a side view of a vessel to be inspected;

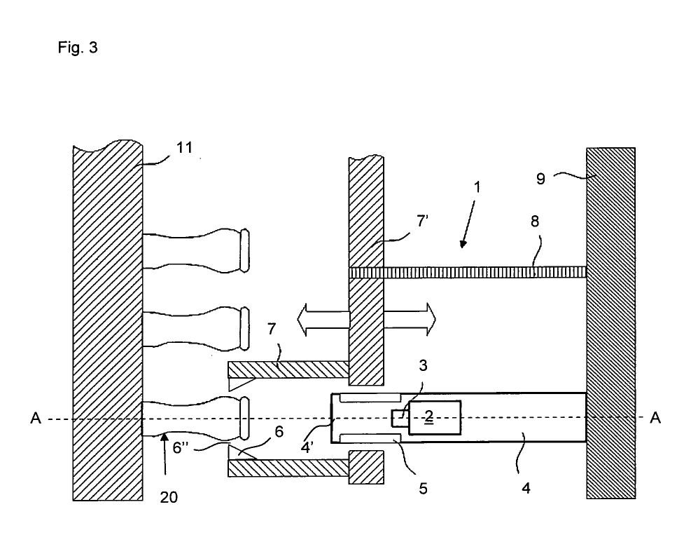

FIG. 2 shows a schematic top view of a production unit having a processing machine for the vessels, the vessel to be inspected being indicated in the inspection position;

FIG. 3 shows a schematic side view of a first embodiment of an inspection apparatus according to the invention, by means of which a vessel to be inspected may be examined in the inspection position in the processing machine;

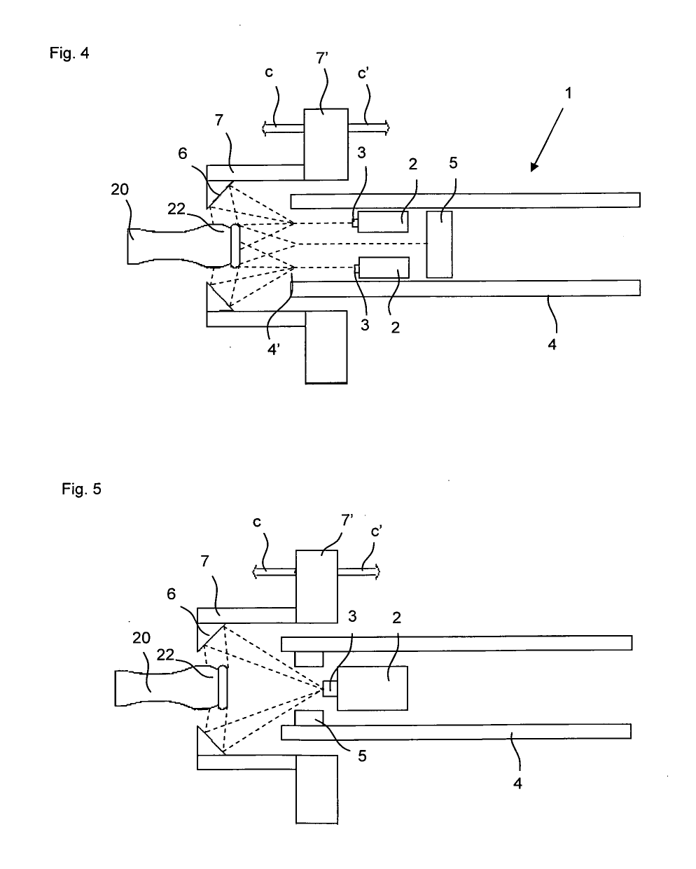

FIG. 4 shows a schematic side view of an alternative embodiment of the inspection apparatus according to the invention;

FIG. 5 shows a schematic side view of an inspection apparatus corresponding to that in FIG. 3, with the beam path [extending] from the vessel section to be inspected, via the mirror-optical system, to the camera,

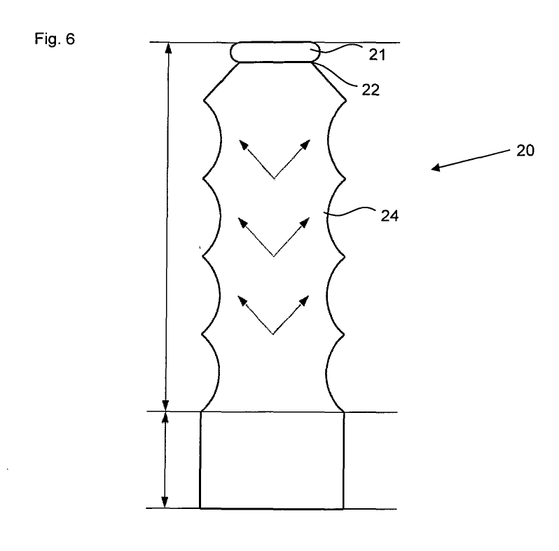

FIG. 6 shows a side view of another vessel to be examined using the inspection unit according to the invention; and

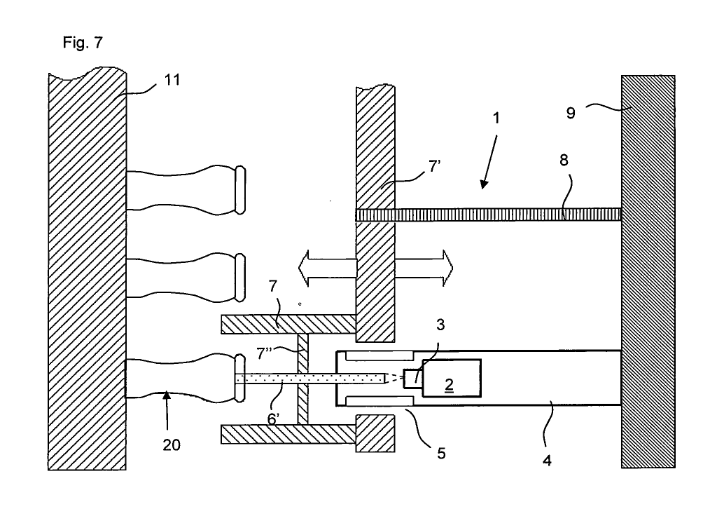

FIG. 7 shows a schematic side view of a second embodiment of an inspection apparatus by means of which the interior of a vessel to be inspected may be examined in the inspection position in the processing machine.

The invention relates to an inspection apparatus by means of which a vessel, such as a can, may be checked for shape and any production defects at the end of production. According to the invention, this check is made inline during ongoing production, wherein each vessel or each can produced is checked.

In the present context, a vessel or can is understood to mean a container having a longitudinal extension which, as shown in FIGS. 1 and 6, may have a contour with a collar, curvatures, and indentations. The opening of the vessel 20, situated at the top, is surrounded at that location by a flanged rim 21. A constriction 22 adjoins beneath the flanged rim 21, so that this neck area of the vessel 20 is not detectable when viewed from above, as indicated by block arrow a, since an undercut is formed. In addition, the inward curvature (see arrow b) as viewed from above is obstructed from view.

In order to now be able to carry out contactless final inspection on a processing machine, such as a necking machine 10 in FIG. 2, which is supplied by a feed conveying device 12 with cans to be processed and is coupled to a discharge belt 13 which transports the vessels away in cups, by means of which both the outer and the inner surface of the vessel may be examined, an inspection apparatus according to the invention is associated with the processing machine 10, in which a plurality of vessels is fixedly mounted on the conveying device 11 and moved by same, at the location in the processing machine 10 indicated by the vessel to be inspected 20 in the inspection position at the end of the processing machine. The inspection apparatus 1 according to the invention which is suitable for this purpose is shown in FIGS. 3, 4, 5, and 7.

The inspection apparatus 1 has a stand 9 to which a jacket tube 4 as a holding device for the camera 2 and the illumination units 5 is affixed. The jacket tube 4 may be a metal tube, for example a steel tube, but may also be made of a plastic or a fiber composite material. The camera 2 together with an associated optical component 3 as well as the illumination units 5 are accommodated in the jacket tube 4, a recording area of the camera 2 and the beam path thereof extending outwardly from an opening 4′ in the jacket tube 4 facing away from the stand 9. As shown in FIG. 3, the jacket tube 4 together with the camera 2 is situated in such a way that the longitudinal axis, i.e., the image recording axis, of the camera forms a shared axis A-A with the longitudinal axis of the vessel 20 to be examined, which is transported by the conveying device 11 of the processing machine. The vessels are firmly clamped in the conveying device 11 so that the vessel 20, which is in the inspection position corresponding to the recording axis A-A, may be exactly positioned in the detection range of the camera 2.

The movement of the vessels through the processing machine by means of the conveying device is not continuous, but, rather, takes place intermittently due to the processing time for a vessel, so that each vessel in succession, with its longitudinal axis in the recording axis A-A of the camera 2 during the time period specified by the processing, briefly comes to a stop in order to be checked at that location. The inspection apparatus 1 is controlled in such a way that the examination sequences of the inspection apparatus 1 proceed in coordination with the holding pattern of the conveying device 11. For this purpose, the inspection apparatus and the conveying device may be coupled via a control device, not illustrated. By use of the camera 2 situated in the jacket tube 4, it is possible to record only the top view of the vessel 20; obscured areas behind outward curvatures such as the flanged rim 21 cannot be recorded in this manner.

To also be able to record these obscured areas via the camera 2, the inspection apparatus 1 according to the invention includes a supporting element 7′ which is movable parallel to the longitudinal axis of the jacket tube 4, and which, as shown in FIG. 3, may travel on a rod 8 which is oriented parallel to the jacket tube 4 which is fastened to the stand 9. In the area at which the retaining tube 7 is attached, the supporting element 7′ has a through opening for the jacket tube 4 which is advantageously equipped in such a way that practically no extraneous light strikes the interior of the retaining tube 7, so that the inner volume of the retaining tube 7 is illuminated primarily by the illumination units 5.

A circumferential mirror element 6 having a through opening 6″ is situated in the retaining tube 7, the diameter of the mirror element being large enough that the retaining tube 7 together with the mirror element 6 is also able to move over a maximum cross section of the vessel 20 to be examined. The mirror element 6 may have a design that is different from a parabolic mirror element, for example, the through opening 6″ being situated in the middle and centered with respect to the axis A-A.

The retaining tube together with the mirror element situated therein, as well as the jacket tube and the supporting element through opening, do not necessarily have to have circular cross sections. As a function of a cross-sectional shape of the vessels to be inspected, retaining tubes together with mirror elements having corresponding cross-sectional shapes may be selected, and the jacket tube and the corresponding through opening in the supporting element may also be adapted in a similar manner.

FIG. 5 shows the vessel 20 inspected using an inspection apparatus 1 corresponding to that in FIG. 3, together with the beam paths made possible by the movable mirror element 6. The movement of the retaining tube 7 for the mirror-optical system 6 which is fastened to the supporting element 7′ is indicated by the block arrows c and c′: arrow c symbolizes the motion in the direction of the image recording configuration, and arrow c′ indicates the withdrawal in order to allow a next vessel to be inspected to be transported into the inspection position. Starting from the illumination units 5, the beam paths extend to the vessel 20 (not illustrated), and from the inspected undercut section 22 extend via the mirror 6 to the lens 3 of the camera 2. Color defects as well as defects such as holes, which would also be understood to mean cracks, which penetrate the material from the outside to the inside, or so-called pinholes, which in the present context are understood to mean a material defect that is smaller than a hole or crack, but which could result in material failure and rupture of the vessel in further processing, such as during filling, may be detected in this way.

FIG. 4 shows an alternative inspection apparatus 1 in which, instead of one camera, two cameras 2 and an illumination unit 5 for the cameras are situated in the jacket tube 4. The improved detection range of the two cameras 2 with respect to the specialized mirror element 6 allows even better assessment of the obscured areas of the vessel 20, such as the case for an asymmetrical vessel in which the beam paths reflected from the vessel cannot be focused by a single camera. The beam path denoted by dashed lines, starting from the illumination unit 5 to the opening 4′ in the jacket tube 4, indicates that here as well an optical transmission element such as fiber optics may be used, so that the illuminated area is outside the jacket tube 4, and therefore the vessel 20, not the interior of the jacket tube, is illuminated. The same may apply for the light beams reflected from the mirror-optical system 6; the beam path is bundled at the jacket tube opening 4′ and is further transmitted to the cameras 2 in the jacket tube 4. For this purpose, it is also conceivable for additional optical components to be used.

The vessel 20 shown in FIG. 6 has, in addition to the constriction 22 beneath the flanged rim 21, a wave profile viewed in the cross section, having four inward curvatures 24 which likewise may be examined using the inspection apparatus according to the invention, in that the specialized mirror element 6 is moved toward the lowest inward curvature, thus allowing a view of the lateral areas of the vessel, which would otherwise not be possible with the camera situated in the top view.

FIG. 7 shows another embodiment of the inspection apparatus 1 according to the invention, which as an alternative or in addition to the inspection apparatus described above having the mirror element 6, may be used for recording the external surface of the vessel 20. The internal surface of the vessel 20 may also be inspected by using a further specialized optical component 6′, in the present case an endoscopic optical system 6′. Even though it is not absolutely necessary for a vessel opening to face toward the camera for examining the external surface, although this is frequently the case depending on the vessel design, for example a constriction such as a bottle neck which adjoins the vessel opening, for internal examination the vessel 20 is in the inspection position with its opening toward the inspection apparatus and the camera. The endoscopic optical system 6′ is now held in the retaining tube 7 by means of a suitable centered retaining element 7″ which positions the endoscopic optical system 6′, which may be an optical fiber, corresponding to the recording axis A-A, i.e., the center axis of the vessel 20. The endoscopic optical system 6′ is now moved via the rod 8 in relation to the stand 9 by the supporting element 7′, which is connected to the retaining tube 7, parallel to the axis with respect to the jacket tube 4, so that the endoscopic optical system 6′ is inserted into the vessel 20 through the opening thereof, while the retaining tube 7 is moved over the vessel 20. The non-inserted end of the endoscopic optical system 6′ is situated with its end face opposite from the camera 2 and its associated optical module 3, wherein as the result of moving the endoscopic optical system 6′, the distance between the end face thereof and the camera 2 continuously changes during an examination operation. The camera or the optical module 3 is now configured in such a way that the end face of the endoscopic optical system 6′ is detected during the examination, whereby a recording area of the camera 2 may be adapted to a moving end face. However, an endoscopic optical system may also be used whose length allows the end facing the camera 2 to be stationarily held, while the opposite end is moved into the vessel interior. In this case, it is sufficient to focus the recording area of the camera a single time on the end face of the endoscopic optical system.

The integration of such an inspection apparatus into the production unit 10 (see FIG. 2) having the conveying device 11 thus allows a rapid, highly precise examination of both the internal and external surface of a vessel, for example a can, so that defective or soiled vessels may be effectively removed from the finishing process. For automating these operations, the camera may also be coupled to an image processing unit, in which, in a manner of speaking, a frame of a correctly implemented vessel is stored, so that by comparing the recorded image to the stored image, the processing unit is able to determine whether the test vessel is intact or has a defect or soiling. The increased accuracy of the examination has been achieved by integrating the inspection into the processing machine within the production unit, and not, as in the past, providing it at the end of the belt, where the vessels are no longer fixed in such a way that they allow highly precise positioning.

LIST OF REFERENCE NUMERALS

| | |
|---|---|
| 1 | Inspection apparatus |
| 2 | Camera |
| 3 | Optical component |
| 4 | Jacket tube |
| 4′ | Jacket tube opening |
| 5 | Illumination device |
| 6 | Optical component/mirror element |
| 6′ | Optical component/endoscopic optical system |
| 6″ | Through opening |
| 7 | Retaining tube |
| 7′ | Supporting element |
| 8 | Rod |
| 9 | Stand |
| 10 | Production unit |
| 11 | Processing machine/conveying device |
| 12 | Feed conveyor belt |
| 13 | Discharge belt |
| 20 | Vessel |
| 21 | Flanged rim |
| 22 | Constriction |
| 24 | Inward curvature |

1. An inspection apparatus for examining vessels which are fixedly mounted on a processing machine, including a camera which has a first optical component and is coupled to an image processing unit, and which is stationarily mounted with respect to a vessel to be inspected which is in an inspection position on the processing machine, wherein the inspection apparatus has a second, movably supported optical element, and
wherein the first, stationarily positioned optical element and the second, movably supported optical element are in operative connection with the camera for recording an image of at least one view in the direction of a vessel opening and at least one view in the direction of a side of the vessel to be inspected facing away from the vessel opening.

2. The inspection apparatus according to claim 1, wherein the second, movably supported optical element is movable in the direction of the vessel to be inspected, in particular parallel to the axis of the vessel to be inspected.

3. The inspection apparatus according to claim 1, wherein the second, movably supported optical element is situated in a movable component which includes at least one first holding device, preferably a retaining tube.

4. The inspection apparatus according to claim 1, wherein the camera together with at least one illumination device is surrounded by a second holding device, in particular by a jacket tube, the jacket tube in particular being made of a metal, metal alloy, plastic, or fiber composite material and having a central longitudinal axis, and wherein an outer diameter of the jacket tube is smaller than an opening cross section of the retaining tube, so that the jacket tube may be at least partially accommodated in the retaining tube.

5. The inspection apparatus according to claim 4, wherein the camera together with the first optical component points along a recording axis in the direction of the vessel which is in the inspection position, and in the inspection position the recording axis being aligned with a central longitudinal axis of the vessel to be inspected, and the retaining tube being situated coaxially with respect to the recording axis in an area between the camera and the vessel, and being movable parallel to the axis in the direction of the vessel, and the opening cross section of the retaining tube being larger than a maximum outer circumference of a section of the vessel to be inspected, so that in an image recording configuration at least the section of the vessel to be inspected may be accommodated in the retaining tube, and for providing the operative connection between the second optical element and the camera, a beam path extends from the illumination device to the section of the vessel to be inspected, and from there extends over the second optical component to the first optical component of the camera.

6. The inspection apparatus according to claim 3, wherein the second optical component is
a mirror, in particular a mirror having a concave curvature or a parabolic mirror, having a central through opening, and/or
an endoscopic optical system,
wherein the endoscopic optical system is held in the retaining tube by a retaining element, parallel to and centered with respect to the central longitudinal axis of the retaining tube, and a first end of the endoscopic optical system faces the camera, and a recording area of the camera is adjustable on an end face at the first end of the endoscopic optical system via the first optical component, and the opening of a vessel in the inspection position faces a second end of the endoscopic optical system.

7. A production unit for producing vessels, including at least one processing machine for processing the vessels, which is fixedly mounted in the processing machine on a moving conveying device for moving the vessels along multiple processing stations of the processing machine, and an inspection apparatus according to claim 1 for examining the quality of a vessel after processing.

8. The production unit according to claim 7, wherein the inspection apparatus includes the second holding device in which the camera together with the first optical component and the at least one illumination device are fastened, and which is positioned in the processing machine in relation to a vessel to be inspected, which is in an inspection position, in such a way that the camera together with the first optical component points along the recording axis in the direction of the vessel to be inspected, and the recording axis is aligned with a central longitudinal axis of the vessel in the inspection position, wherein the inspection apparatus is coupled to the processing machine via a control device for control in coordination with the conveying device in order to examine the quality of the vessel in the inspection position during a holding phase of the conveying device after the processing, the holding phase being specified by a time period that is necessary for a vessel to be processed.

9. The production unit according to claim 7 or claim 7, wherein the vessels are cans, and the processing machine is a necking machine for shaping the can bodies, in particular for shaping a can opening, which upstream is operatively coupled to a feed conveyor belt and downstream is operatively coupled to a discharge belt.

10. An inspection method for examining the quality of a vessel after processing of a vessel in a production unit for producing vessels according to claim 7, comprising the following steps:
arranging the inspection apparatus in relation to the vessel to be inspected in an inspection position, thus setting a stationary position of the first optical element for recording the image of at least one view in the direction of a vessel opening, and
movably supporting the second optical elements in the direction of a side of the vessel to be inspected facing away from the vessel opening for recording the image of a view of the side of the vessel to be inspected facing away from the vessel opening, and operatively connecting the first, stationarily positioned optical element and the second, movably supported optical element together with the camera, and
carrying out image recording of a vessel, which in each case is in the inspection position and is fixedly mounted, in the processing machine by the inspection apparatus via the camera.

11. The inspection method according to claim 10, comprising the following step:
controlling the inspection apparatus by the control device in coordination with the conveying device, and carrying out the examination of the quality of the vessel in the inspection position during a holding phase of the conveying device, the holding phase being specified by a time period that is necessary for a vessel to be processed.

12. The inspection method according to claim 10,
wherein the configuration of the inspection apparatus comprises:
moving the component of the inspection apparatus which is movable with respect to the stationary camera into the image recording configuration of the retaining tube which is surrounded by the component together with the second optical component by moving the retaining tube parallel to the axis with respect to the recording axis in the direction of the vessel to be inspected, and
accommodating the section of the vessel to be inspected in the retaining tube.

13. The inspection method according to claim 10, comprising the following step:
taking interior image recordings of the vessel, whose opening faces toward the camera, by means of the endoscopic optical system.
